(19) United States
(12) Patent Application Publication
(10) Pub. No.: US 2013/0093310 A1
(43) Pub. Date: Apr. 18, 2013

(54) HIGH INTENSITY DISCHARGE LAMP WITH COILED WIRE IGNITION AID

(71) Applicant: Agoston BOROCZKI, Budapest (HU)

(72) Inventor: Agoston BOROCZKI, Budapest (HU)

(73) Assignee: GENERAL ELECTRIC COMPANY, Schenectady, NY (US)

(21) Appl. No.: 13/273,654

(22) Filed: Oct. 14, 2011

(51) Int. Cl. H01J 61/04; H01J 61/20; H01J 61/16

(52) U.S. Cl. 313/54; 313/631

(57) ABSTRACT

This disclosure features a high intensity discharge lamp comprising an electrically insulating arc tube comprised of light transmissive material. Electrical conductors or electrodes are each spaced apart from each other inside the arc tube. A shroud comprised of light transmissive material encloses the arc tube. An electrically conductive frame member is disposed in an interior of the shroud and is electrically connected to one of the electrical conductors. An ignition aid is electrically attached to the frame member and comprises a coil of electrically conductive wire that is disposed around the arc tube.

### FIELD OF THE INVENTION

This disclosure relates to high intensity discharge lamps, and in particular, to ignition aids used in such lamps.

### BACKGROUND OF THE INVENTION

Differences exist in speed of electric breakdown and the number of electrons needed to initiate a self-sustained electric discharge, but the underlying breakdown mechanism is the same for low pressure discharge lamps (e.g., fluorescent lamps) or high pressure discharge lamps (high intensity discharge lamps). Discharge is initiated between two conductors, the electrodes of the lamps, that are given opposite electric potential. The space between the electrodes usually comprises a starting gas, and efforts are made to maintain the quality/purity of the gas by enclosing it in a hermetic vessel. The essential end result of the discharge breakdown is the creation of a discharge plasma between the two electrodes. This early phase of discharge lamp operation is often called ignition of the lamp. Plasma is defined as a conductive gas phase medium, containing equal proportions of electron and ions, which allows for conduction of electric current through an otherwise insulator material, i.e., the gas in its initial state.

Initially, the starting gas contained in the arc tube is non-conductive. If an electric potential is applied on the electrodes, this creates a favorable situation to strip the outer orbital electrons from the atoms of the gas and thus create negatively charged free electrons and electrically positive gas ions, which are then accelerated though the gas by the electric field generated between the conductors, and initiates more electrons by collision with gas atoms, which in turn are ionized by the same mechanism. If the electric field is high enough, each electron thus created will potentially create additional electrons by inelastic collisions with gas atoms and ions, and initiates an electron avalanche. Such an electron avalanche creates the self-sustaining electric discharge, which is the source of light radiation in electric discharge lamps. However, to create such avalanche electrons by simple dielectric breakdown of the gas atoms by the electric field requires several kilovolts of electric potential. Higher and higher electric potentials require more expensive external electrical circuitry, and may not be commercially feasible. Unwanted breakdown can also occur in the outer jacket and in the cap-base region.

Discharges for commercial lighting applications employ an additional source of free electrons, which removes the need for generating such high voltages to initiate the discharge. Such external sources can be a heated filament, use of the ever present cosmic rays, or providing a source of electrons by radioactive decay. Heated filaments for electrodes are used in fluorescent lamp but are not practical in high intensity discharge (HID) lamps having rod shaped electrodes, and the cosmic ray background radiation is usually insufficient to dramatically reduce the need for very high electric fields needed to initiate the ignition, unless other methods are used to lower the breakdown voltage.

For providing a source of electrons by radioactive decay, typically what has been used in the past in the HID arc tube is a radioactive gas, such as Kr⁸⁵ with most of the decay products being beta particles (i.e., electrons). Kr⁸⁵ has a half-life of 10.8 years, with 99.6% of the decay products being beta particles (i.e., electrons) having a maximum kinetic energy of 687 keV. These electrons have very high energy, and in many respects are ideal to initiate electric breakdown in gases, and used widely as such for these applications. But to provide enough of these high energy electrons by radioactive decay, significant quantity of this gas has been used in HID lamps.

The presence of Kr⁸⁵ in such lamps diminishes the need for providing very high electric potential on the electrodes, which makes the external electrical circuitry (a lamp ballast with an ignitor) and systems design simpler and more cost effective. Typical applications use such a radioactive gas with a ballast and ignitor circuit that provides a high electric pulse for a very short duration, typically in the millisecond (microsecond) range, that is very effective in creating the electron avalanche referred to earlier. However, recent UN2911 government regulations limit the amount of radioactive Kr⁸⁵ used in lamps. These regulations proscribe the HID lamp manufacturers from using the large quantity of Kr⁸⁵ gas that has been previously used, as described in preceding paragraph.

A number of ignition aids have been designed for improving the ignition of high intensity discharge lamps. U.S. Patent application Pub. No. 2002/0185973 discloses a lamp in which wire is wrapped around both legs of the arc tube and its central body as both an ignition aid and for containment, but are not connected to the electrodes. Another reference, U.S. Pat. No. 5,541,480, discloses an ignition aid in which a conductor that is coated on an exterior surface of an arc tube between the electrodes is connected to a conductive frame wire that contacts an electrode. U.S. Pat. No. 6,222,320 discloses an ignition aid for a lamp including an arc tube having a central body portion and smaller diameter legs extending from the body portion, wherein a conductor wire that is in contact with a conductive frame wire that contacts one of the electrodes, contacts only the central body portion of the arc tube close to at least one of the electrodes.

### BRIEF DESCRIPTION OF THE INVENTION

A need to reduce the Kr⁸⁵ content in HID lamps exists, but such reduction could have serious consequence to discharge initiation or ignition, and consequently unacceptable performance. This invention describes a means to obviate this disadvantage of lowering the Kr⁸⁵ gas content.

It should be appreciated that terms such as upper, lower, top, bottom, right, left, and the like are relative terms that will change with the orientation of the lamp. These terms are used for improving understanding in this disclosure and should not be used to limit the invention as defined in the claims.

A first general embodiment of this disclosure features a high intensity discharge lamp comprising an electrically insulating arc tube comprised of light transmissive material. Electrical conductors, (e.g., electrodes) are each spaced apart from each other inside the arc tube. A shroud comprised of light transmissive material encloses the arc tube. An electrically conductive frame member is disposed in an interior of the shroud and is electrically connected to one of the electrical conductors. An ignition aid is electrically attached to the frame member and comprises a coil of electrically conductive wire that is disposed around the arc tube. Another electrically conductive frame member is also disposed in the shroud, and is connected to the second electrode inside the arc tube.

Referring to specific features of the first embodiment, the arc tube can include a central portion and two smaller sized legs each of which extends from the central portion, the central portion forming a discharge region inside the arc tube. The coil of wire can be disposed around one of the legs. The wire can be welded to the frame member as a coil. The wire can also be welded to the frame member as an uncoiled portion that extends from the coil. The discharge region can comprise inert starting gas and a dose fill of, for example, mercury and metal halides. A starting gas as a mixture of argon gas and/or xenon gas, and Kr⁸⁵ gas, present in the discharge region can have an activity concentration of not greater than 0.16 MBq/liter. The electrodes can include a first electrode attached to a usually short frame member to which voltage is applied and a second electrode; the frame member can be electrically connected to the second electrode within the arc tube and to the coil that is disposed around one of the legs but electrically insulated from the first electrode. In another aspect, each of two coils of wire are electrically attached to each of two frame members in electrical contact with each of two electrical conductors and are disposed around each of the legs having the electrical conductors at opposite potential to the coils of wire.

The frame wire members or the coil of wire can be comprised of a base metal selected from the group consisting of Nb, Mo, Ta, Pt, Re, W, Ni, Fe and combinations thereof, or a combination of any of the base metals with cladding comprised of one or more of the base metals. The coil can also be wrapped around one of the legs of the arc tube more than 360 degrees. The coil can also have non-circular loops. The wire of the coil can extend in loops around an axis that, for most of a length of the coil, extends transverse to a longitudinal direction in which the electrodes extend. This is, the wire is not uncoiled wire wrapped around an arc tube leg to form a coil wherein the axis of the coil extends in a direction that the electrodes extend.

A second embodiment is the same as the first embodiment except that the arc tube is described more narrowly. The arc tube includes a central portion and two smaller sized legs each of which extends from said central portion, the central portion forming a discharge region inside the arc tube. In addition, the coil of wire is disposed around one of the legs. Any of the specific features described above with regard to the first embodiment can apply in any combination to the second embodiment.

Many additional features, advantages and a fuller understanding of the invention will be had from the accompanying drawings and the Detailed Description of the Invention that follows. It should be understood that the above Brief Description of the Invention describes the invention in broad terms while the following Detailed Description of the Invention describes the invention more narrowly and presents embodiments that should not be construed as necessary limitations of the broad invention as defined in the claims.

### BRIEF DESCRIPTION OF THE DRAWINGS

FIG. 1 is a side elevational view of a single ended high intensity discharge lamp with coil ignition aid of this disclosure;

FIG. 2A is a vertical cross-sectional view of the lamp of FIG. 1;

FIG. 2B is an enlarged cross-sectional view of the arc tube of FIG. 2A;

FIG. 3 is a side elevational view of a double ended high intensity discharge lamp with coil ignition aid of this disclosure;

FIG. 4A is a cross-sectional side view of a comparative arc tube showing axial electric field lines between a wire and electrically conductive feedthrough in the arc tube; FIG. 4B is an end view of the arc tube of FIG. 4A showing radial electric field lines between the wire and feedthrough; and FIG. 4C is a perspective view showing the arc tube of FIG. 4A;

FIG. 5A is a cross-sectional side view of an arc tube of this disclosure showing axial electric field lines between a coil of wire and electrically conductive feedthrough in the arc tube; FIG. 5B is an end view of the arc tube of FIG. 5A showing radial electric field lines between the coil of wire and feedthrough; and FIG. 5C is a perspective view showing the arc tube of FIG. 5A;

FIG. 6 is an end view of an arc tube of this disclosure showing electrical connection between the coil of wire and frame member of the lamp;

FIG. 7 is an end view of an arc tube of this disclosure showing another electrical connection between the coil of wire and frame member of the lamp using electrically conductive tubes on the ends of the coil;

FIG. 8 is an end view of an arc tube of this disclosure showing electrical connection between the coil of wire and frame member of the lamp, wherein the wire includes uncoiled interval portions of the wire that are connected to the frame member;

FIG. 9 is a perspective view of an arc tube of this disclosure showing electrical connection between the coil of wire and frame member of the lamp, wherein the wire includes uncoiled interval portions of the wire that are connected to the frame member; the loops of the coil have a non-circular shape; and

FIG. 10 is a perspective view of an arc tube of this disclosure in which the coil is wrapped around a leg of the arc tube by more than 360 degrees.

### DETAILED DESCRIPTION OF THE INVENTION

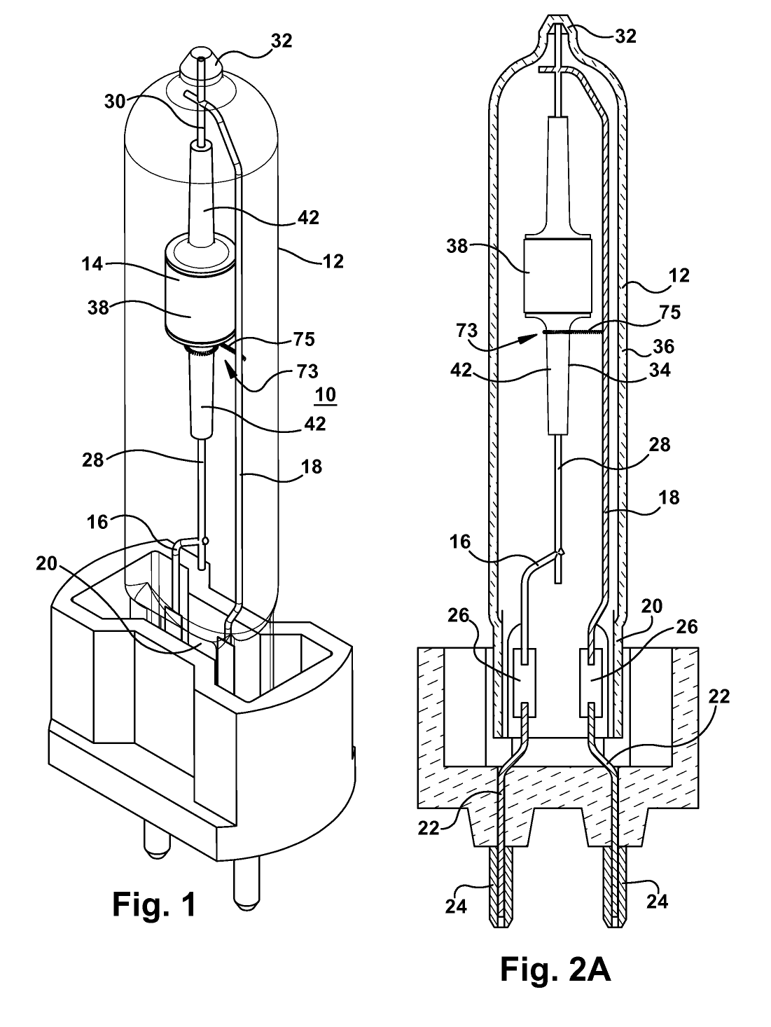

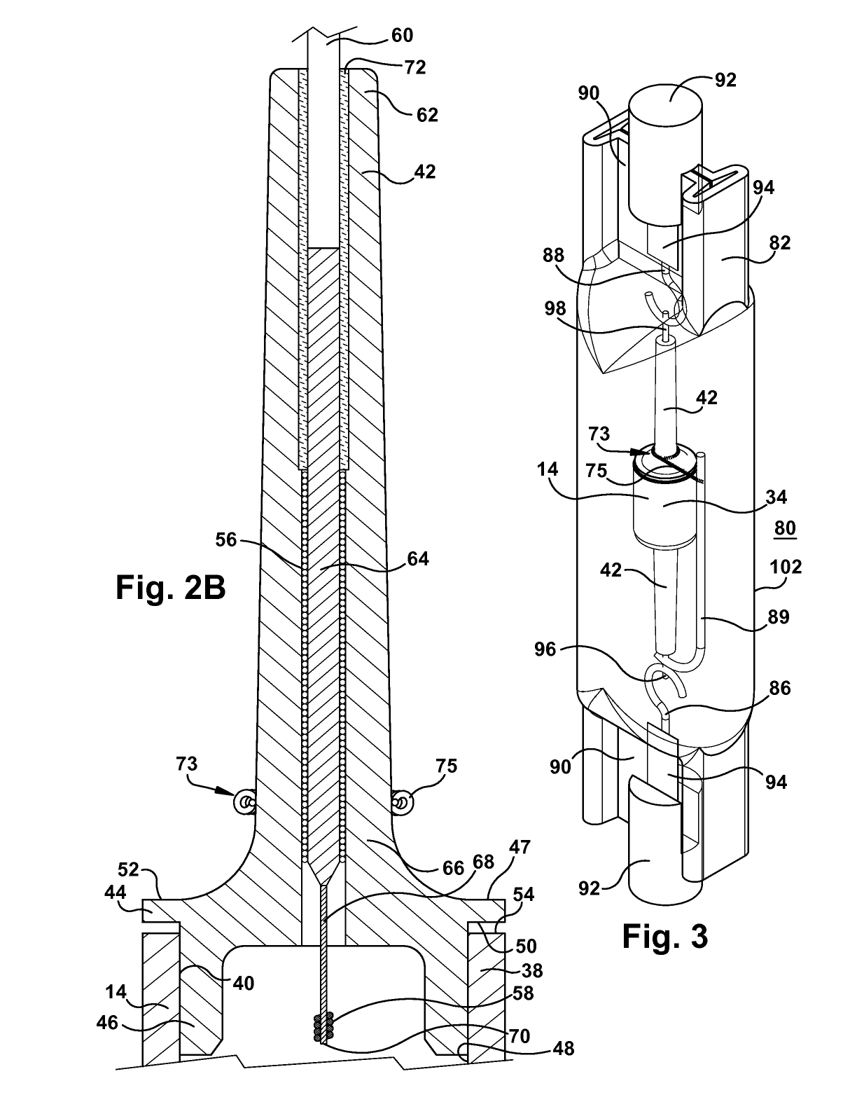

Referring to FIG. 1 and FIG. 2A, a ceramic metal halide high intensity discharge lamp 10 includes an outer shroud or bulb 12 enclosing an arc tube 14. This is a single ended lamp in that electrical contacts are located on only one end of the lamp. Electrically conductive frame members or wires 16, 18 are embedded in a glass pinch portion 20 at one end of the outer bulb 12. Leads 22 extending from contact pins 24 external to the outer bulb 12 are electrically connected to the frame wires 16, 18 by electrically conductive foil 26 located in the pinch portion 20. Each foil 26 is welded to one of the leads 22 and to one of the frame wires 16, 18. Electrically conductive feedthroughs 28, 30 extend into each end of the arc tube. The lower feedthrough 28 is welded to the short frame member 16 while the upper feedthrough 30 is welded to the long frame member 18. The upper feedthrough 30 extends upwardly past the connection with the long frame member 18 and is retained in place by being in contact with a portion 32 of glass of the outer bulb that has been partially melted around the feedthrough 30 during manufacturing. The long frame member 18 extends along the length of the arc tube but is spaced apart from a side 34 of the arc tube 14 near a side wall 36 of the outer bulb 12. The frame members 16, 18 are formed of rigid wire and support the arc tube 14 inside the outer bulb 12 preventing its movement.

Referring to FIG. 2B, the arc tube 14 includes a tubular central barrel shaped portion 38 of substantially constant diameter and openings 40 at either end of the barrel portion. Two legs or capillaries 42 extend from the central portion 38. The arc tube body and legs can be formed of light transmitting ceramic material such as polycrystalline alumina. Each of the legs 42 can include a flange 44 and a boss 46 extending from the flange into the opening 40 of the central portion into an interior discharge region 48 of the barrel portion 38. The legs each include inner flange surface 50 and outer flange surface 52, the inner flange surface 50 abutting a side face 54 of the cylindrical barrel portion 38. In particular, each leg includes a plug portion 47 that extends from a flat tapered portion of the leg, including a curved surface, to an outer periphery of the outer flange surface 52. The legs 42 include passages 56 along their length. The conductive feedthroughs 28, 30 extend into the passages 56 and are electrically connected to electrodes 58 that are spaced apart from each other in the discharge region. The feedthroughs 28, 30 are electrically conductive. In one example, there is a niobium feedthrough portion 60 that extends from outside the leg into the distal portion 62 of the leg remote from the central portion 38. The niobium feedthrough portion 60 is electrically connected to a molybdenum feedthrough portion 64, which can include a central wire with material coiled around it. At proximal leg portion 66 near the central portion 38 and connected to the molybdenum feedthrough is a tungsten portion 68 of the electrode 58 also including conductive material coiled around it and having a tip 70. The coils around the feedthrough portion 64 and around the tungsten portion 68 are substantially the same material as the wire they wrap around. The wire is comprised of a base metal selected from the group consisting of Nb, Mo, Ta, Pt, Re, W, Ni, combinations thereof and a combination of any of the above base metals with cladding composed of one or more of the base metals. The cladding, besides other advantages, improves weldability of the wire. Those skilled in the art will appreciate in reading this disclosure that various differences in the feedthrough and electrode design and composition can be made without departing from the scope of this disclosure. A glass frit 72 is used inside the passages 56 of the legs 42, for example, around the niobium and molybdenum feedthrough portions, to hermetically seal the arc tube after ionizable material has been charged into it. The ignition aid includes a coil 73 of wire 75 disposed around the arc tube leg and electrically attached to the frame member 18. The coil 73 may wrap around the arc tube leg 42 at a location of the molybdenum feedthrough, for example. The coil can be larger or smaller than what is shown in the figures.

Referring to FIG. 3, a ceramic metal halide high intensity discharge lamp 80 of a second embodiment includes an outer shroud or bulb 82 enclosing an arc tube 14. This is a double ended lamp in that contacts are located at both ends of the lamp. Electrically conductive end frame members 86, 88 are embedded in glass at each of the opposite pinch portions 90 of the outer bulb 82. Contacts 92 external to the outer bulb are electrically connected to electrically conductive foil 94 located in the pinch portions 90. Each foil 94 is welded through an electrical conductor to a connector fitted into one of the contacts 92 and to one of the end frame members 86, 88. The electrical connection between the foil and contact is not shown. Electrically conductive feedthroughs 96, 98 extend into each end of the arc tube 14. The lower feedthrough 96 is welded to a central frame member 89 that extends along the length of the arc tube but is spaced apart from a side 34 of the arc tube 14 near a side wall 102 of the outer bulb. The frame members 86, 88, 89 are made of rigid wire and support the arc tube 14 inside the outer bulb 82 preventing its movement. The central frame member 89 is electrically connected to one conductor (feedthrough 96) that extends into the arc tube 14 and is electrically attached to coil 73 of wire 75 around the other conductor (feedthrough 98) on the other leg of the arc tube while being electrically insulated from that conductor. The arc tube 14 and its feedthrough portions (FIG. 2) of the lamp of the first embodiment have the same features as the arc tube 14 and its feedthrough portions of the lamp of the second embodiment (FIG. 3).

Into the discharge region 48 is charged an ionizable material including an inert gas (e.g., argon and/or xenon), metal halide and mercury. Krypton 85 (Kr⁸⁵) gas may also be used in the discharge region in amounts reduced to comply with government regulations; for example, a mixture of argon and/or xenon gas, and Kr⁸⁵ gas, present in the discharge region can have an activity concentration of not greater than 0.16 MBq/liter. The composition of the gas in the arc tube at room temperature is argon and/or xenon and krypton with some mercury. The dose in the lamp, for example, can include 5.7 mg of Hg and the following (weight %) metal halides: 51.2% NaI, 6.8% TlI, 16.6% LaI₃ and 25.4% CaI₂. The total dose weight of these halides can be 12 mg.

Electrical current supplied to the contacts reaches the electrodes via the frame members and feedthroughs, and generates an arc between the electrodes. One electrode (e.g., the electrode connected to feedthrough 28 in FIG. 1) is provided an AC operating voltage by the ballast while the other electrode is at the opposite potential. The electrode connected to feedthrough 30 in FIG. 1 can be grounded. Ignition voltage pulses and rms operating voltage are provided to the lamp via the ballast. It should be appreciated that the one electrode referred to above can be the opposite as what is shown and described regarding each of FIGS. 1 and 3. For example, the electrode connected to feedthrough 30 can receive the full applied voltage from the ballast while the electrode connected to feedthrough 28 is grounded. Alternatively, the applied voltage to the lamp can be a floating voltage, i.e., each electrode can have voltage applied to it in AC cycle (equal, but opposite).

An ignition aid is used to improve ignition of the lamp. The ignition aid includes the coil 73 of electrically conductive wire 75 that is electrically attached to the frame member (18, 89) and is disposed around a leg of the arc tube around a feedthrough extending in that leg. The coil 73 of wire 75 is spaced apart and is electrically insulated from the feedthrough it is disposed around by the electrically insulating ceramic material of the arc tube leg. While not wanting to be bound by theory it is believed that the coil 73 and feedthrough in the arc tube leg (and/or electrode in the arc tube central portion) along with the nonconductive gas in the arc tube leg, function as a capacitor. Typically, there is no coil ignition aid wrapped around the arc tube leg with the feedthrough at the same electrical potential as the coil aid as shown in the drawings or at the central portion of the arc tube where no electrically conducting component of the arc tube can be found at all. For example, turning to FIG. 1, there is no electrical conductor (coil) on the upper leg 42 or on the barrel portion 38 in this example. However, the lamp can be modified from what is shown to include coiled wire on the arc tube central portion as well as around the leg, except that the wire would not extend in a region of the arc tube central portion between the electrodes. In addition, the coiled wire could extend around the other leg, but this lamp would employ another frame member on the other side of the lamp to which it is connected. Although the coiled wire is typically disposed proximal to the lower electrode (FIG. 1), the coiled wire might also be disposed proximal to the upper electrode instead as shown in FIG. 3.

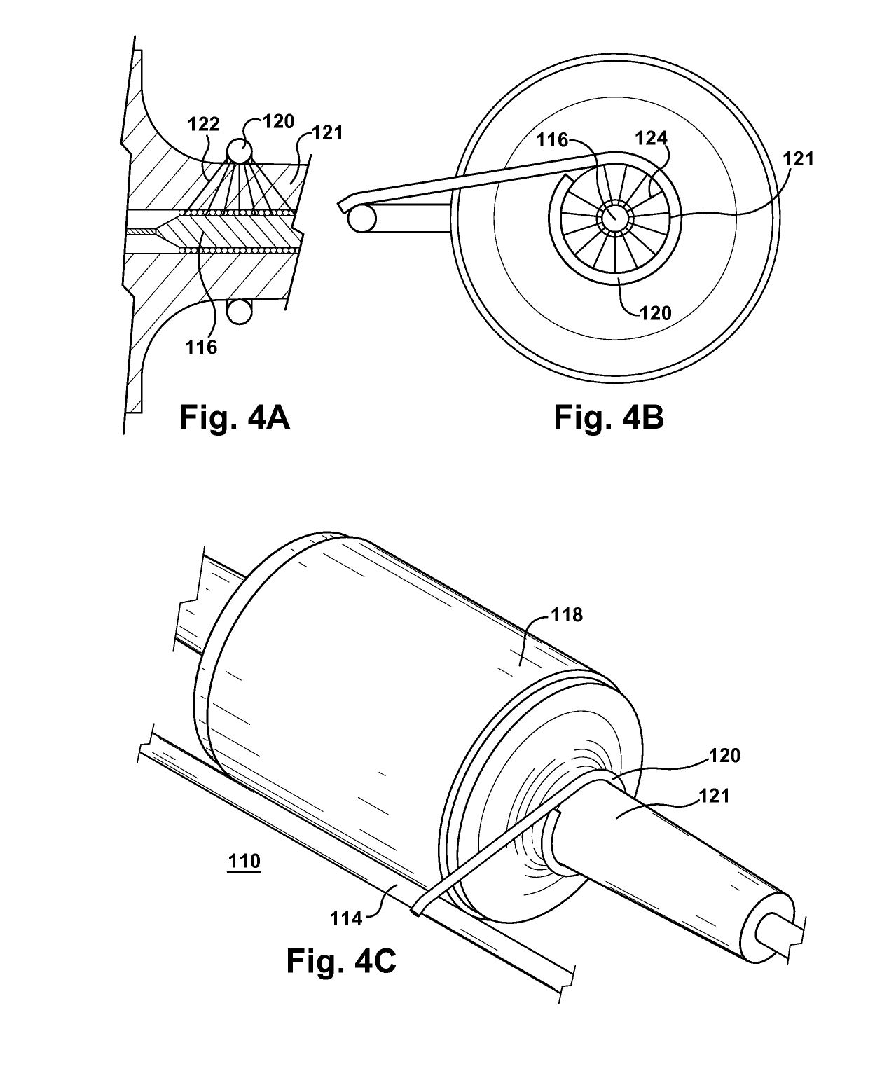

Referring to comparative FIG. 4, an explanation of the improved performance of the coiled wire compared to uncoiled wire will now be described. FIG. 4A, FIG. 4B and FIG. 4C show a high intensity discharge lamp 110 including a frame wire 114 connected to a first electrode, an electrical conductor 116 connected to a second electrode of an opposite potential, and an arc tube 118 in which the electrode 116 extends. Uncoiled wire 120 that is electrically connected to the frame wire 114 wraps around a leg 121 of the arc tube. The axial electric field concentration for the fully wrapped case is shown in FIG. 4A. This shows that the electric field lines 122 between a point source of the wire 120 (solid circle) and an adjacent electrical conductor 116 extends along a portion of the length of the electrical conductor. FIG. 4B shows radial electric field lines 124 extend radially from the conductor 116. The measure of electric field strength is proportional to number of electric field lines per unit surface area crossed by the lines. It can be seen that for a given surface area, the electric field lines are more concentrated near the conductor 116 than they are near a circumference of the arc tube leg 121. This shows that there are regions in the arc tube leg near the wall of the leg where the gas is not subjected to a high electric field concentration.

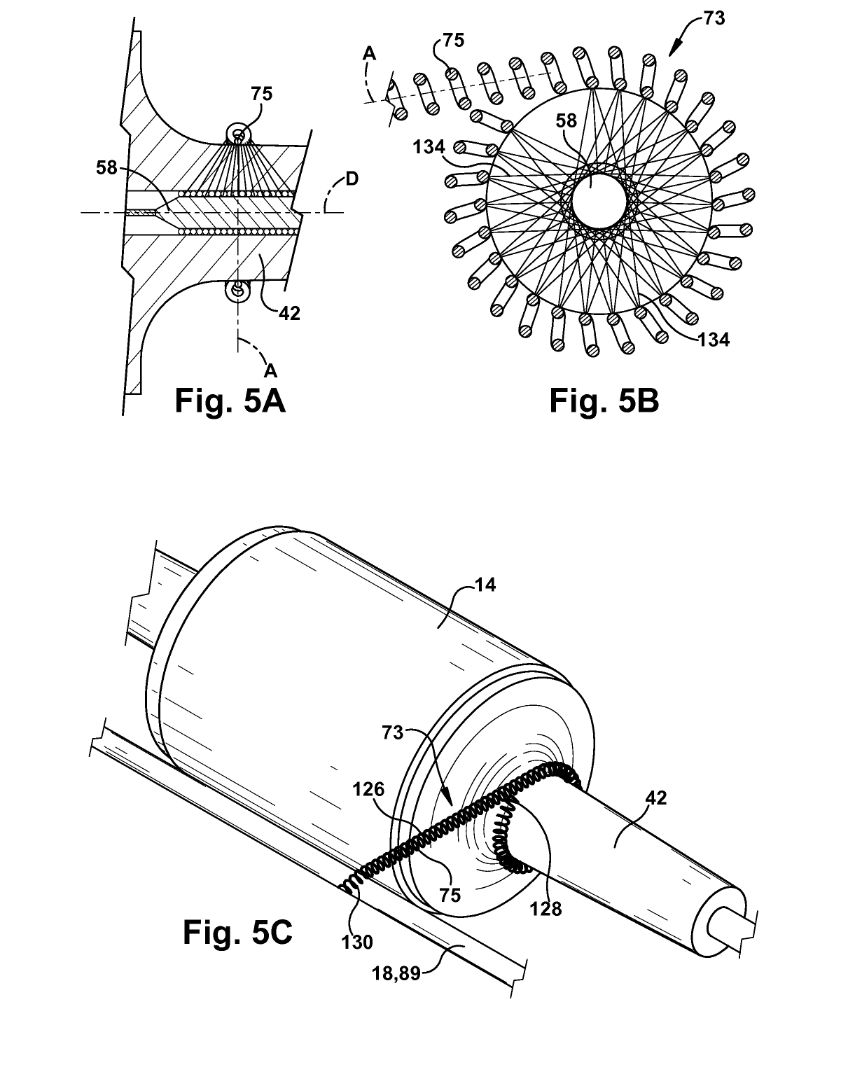

Referring to FIG. 5C of this disclosure, the coil 73 of wire 75 has a central portion 126 located between two end portions 128, 130. The coil 73 is electrically attached at one end 130 to the frame member 18, 89 and extends around the arc tube leg 42 via the central portion 126 of the coil, the other end of the coil 128 being unwelded, for example. The axial electric field concentration is shown in FIG. 5A. This shows that the electric field lines 132 between a point source of the coil 73 of wire 75 (small circle) and an adjacent electrical conductor (electrode 58 or feedthrough portion) extends along a portion of the length of the electrical conductor. The axial electric field lines of FIG. 5A are closer together than those of FIG. 4A. FIG. 5B shows the radial electric field concentration. Because the wire 75 is coiled as it extends around the arc tube leg, there are points of the turn of the coil 73 at which the wire is nearer to the feedthrough and points of the turn of the coil at which it is farther away from the feedthrough. For simplicity, in FIG. 5B only the radial electric field lines 134 with the electrical conductor 58 from the points of the turn of the coil at which the wire is nearer to the feedthrough are shown. In comparing FIGS. 4B and 5B, it is apparent that the electric field lines in FIG. 5B are much closer together near the circumference of the arc tube leg (42, 121) than in FIG. 4B, as well as in the gas volume between the electric conductor 58 and the arc tube leg. This is because there are many closely spaced small diameter wire 75 points in contact with the arc tube leg 42 which concentrate the electric field lines so that the electric field lines are much closer together per surface area along the wall of the arc tube leg, as well as inside the gas volume. This means that the gas in the arc tube leg will be exposed to a greater electric field concentration using coiled wire rather than uncoiled wire. In the coiled wire wrapped around the arc tube leg there are loops of the wire extending along an axis A (FIGS. 5A and B) that, for most of a length of the coil, extends transverse to the direction D in which the electrode (or feedthrough) extends.

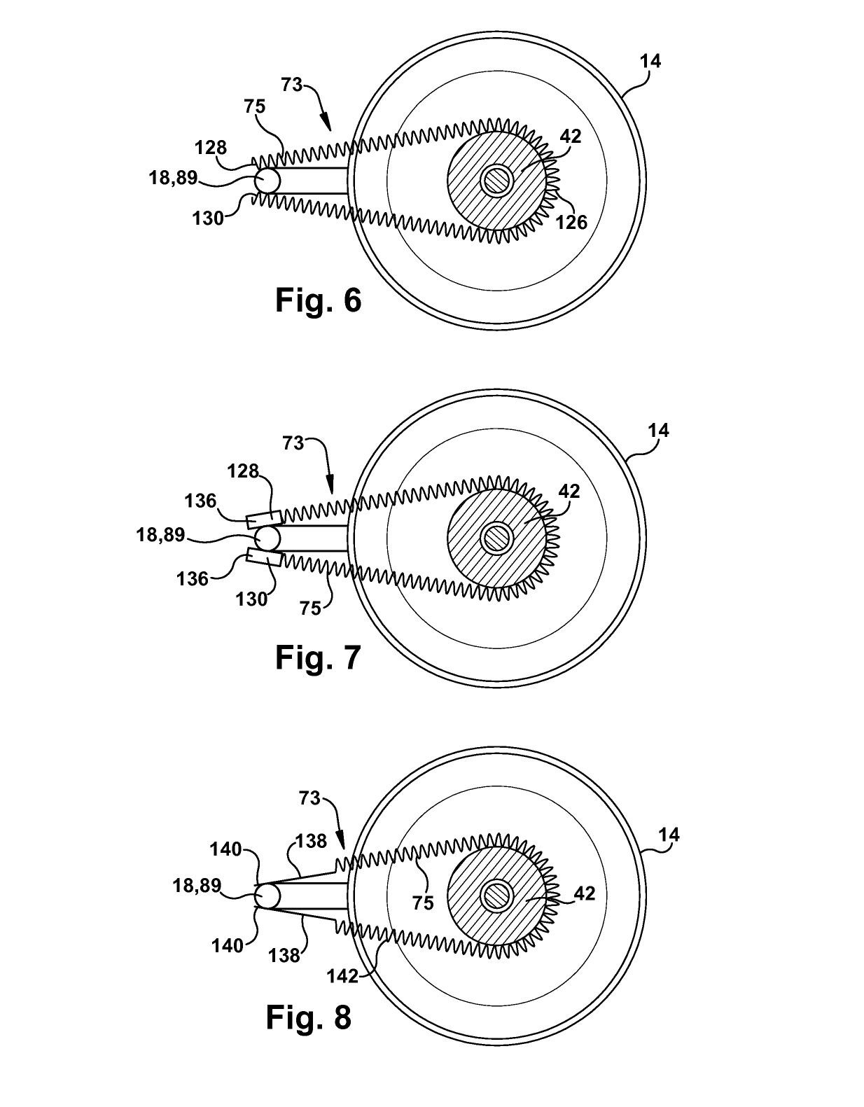

FIGS. 6, 7 and 8 show different ways in which the wire may be welded to the frame member. In FIG. 6, the coil 73 of wire 75 is welded to the frame member 18, 89 in the shape of the coil. Here, the central portion 126 of the coil wraps around the arc tube leg 42 while both ends 128, 130 are welded to the frame member so as to be electrically attached. One disadvantage is that it is difficult to weld a smaller wire to a larger wire, let alone a coil of wire. FIG. 7 employs electrically conductive tubes 136 that are placed at the ends 128, 130 of the coil 73 of wire 75. The tubes 136 are welded to the frame member 18, 89, melting the tube 136, coil 73 of wire 75 and portion of the frame member 18, 89 together. FIG. 8 shows that the wire 75 can include uncoiled intervals 138 at end portions 140 and a coil 73 of the wire 75 at a central portion 142 that wraps around the arc tube leg 42. The uncoiled intervals 138 are welded to the frame member 18, 89 at both end portions 140. In each of these ways of welding the coil to the frame member, the coil is present at a location between the frame member 18, 89 and the arc tube leg 42 and the coil is present in a central portion that is disposed around the arc tube leg.

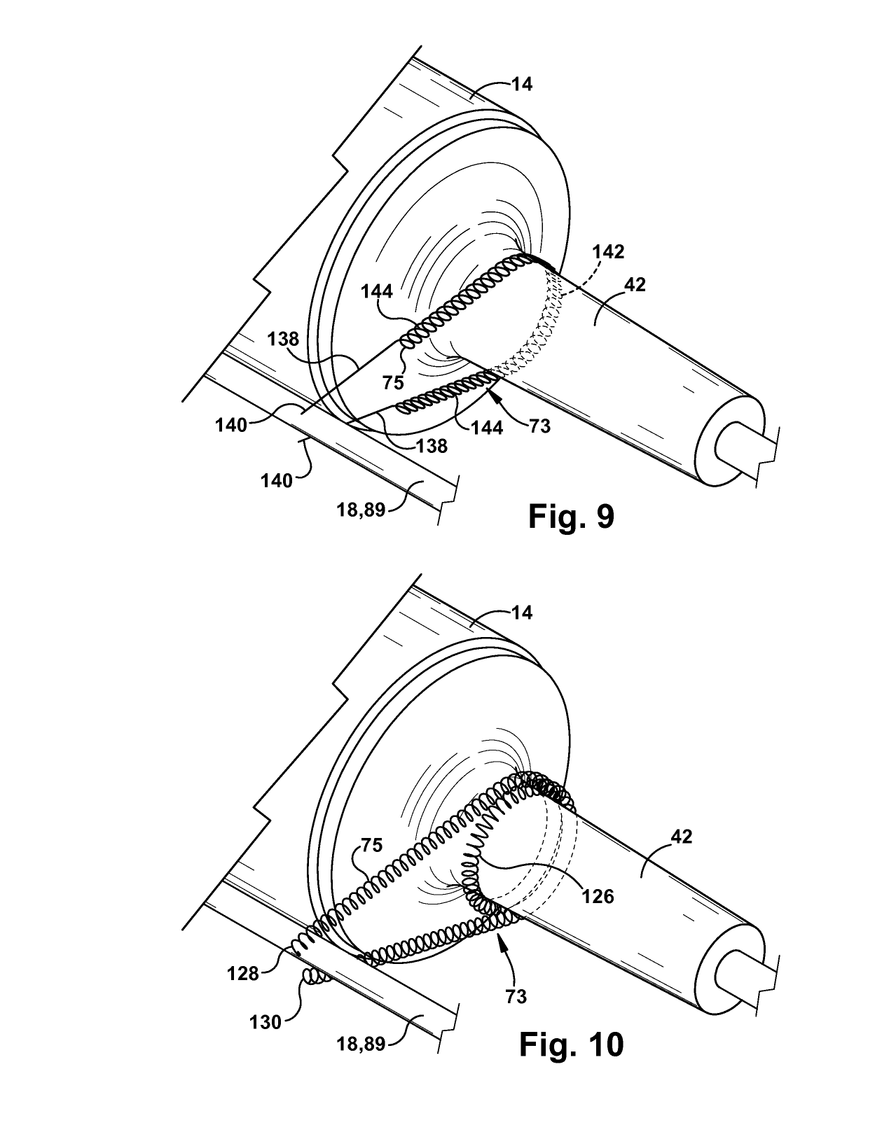

FIG. 9 shows that the coil 73 of wire 75 need not have circular loops (FIG. 8) but can stretch or flatten loops 144 of the coil 73 such that the loops are ellipsoidal. In this particular example, intervals 138 of the wire 75 are uncoiled, while the central portion 142 of the wire includes the ellipsoidal loops 144 of the coil 73. The uncoiled intervals 138 of the wire at both end portions 140 are welded to the frame member. It should be apparent from FIGS. 6-9 that the coiled wire is forgiving in terms of stresses applied to the coil due to movement of the arc tube or the frame member in the lamp, compared to uncoiled wire (FIGS. 4A-C), which can be another advantage of the invention. That is, if there is movement between one or both of the frame wire and arc tube leg, the coil will stretch without failing.

FIG. 10 shows a coil 73 of wire 75 electrically attached to the frame member 18, 89 like in FIG. 6. However, the difference is that the central portion of the coil 126 between the end portions 128, 130 wraps around the arc tube leg 42 more than 360 degrees, i.e., for multiple turns. The coil could be wrapped around the arc tube leg for even more turns than are shown in FIG. 10.

In addition to the increased density of radial electric field lines, a reason the coiled wire is a further enhancement of the lamp starting phenomenon is described below. For purposes of explanation, a conventional discharge lamp does not have the foil starting aid, but contains Kr⁸⁵ gas and Ar gas. A ballast is used to apply the high voltage transient pulse between the electrodes contained in the hermetically sealed discharge region of the arc tube. Relatively high concentrations of Kr⁸⁵ gas that exceed current government regulations (e.g., 6.2 MBq/l) are used in the conventional discharge lamp to allow for the discharge to be initiated reliably over the rated life of such lamps. The electric field generated in the conventional discharge lamp is defined as the applied voltage/gap between the electrodes. The larger the gap between the electrodes, the lower the electric field. The lower the electric field, the harder it is to reliably initiate (ignite) the discharge, even though Kr⁸⁵ gas and the high voltage electric pulse that is provided by the ballast, are present. Referring to FIG. 2A, including the coiled wire aid of this disclosure as shown, the electric field in the lamp is much higher, by virtue of the fact that the gap is now between, for example, the coiled wire and the adjacent electrode. This gap is much smaller than the gap between the electrodes and hence the electric field is much larger, and the creation of the electron avalanche that much easier. Essentially, the upper electrode has been replaced by the coiled wire, as the coiled wire is electrically connected to the upper electrode.

Many modifications and variations of the invention will be apparent to those of ordinary skill in the art in light of the foregoing disclosure. Therefore, it is to be understood that, within the scope of the appended claims, the invention can be practiced otherwise than has been specifically shown and described.

What is claimed is:

1. A high intensity discharge lamp comprising:
an electrically insulating arc tube comprised of light transmissive material;
electrical conductors each spaced apart from each other inside said arc tube;
a shroud comprised of light transmissive material enclosing said arc tube;
an electrically conductive frame member disposed in an interior of said shroud that is electrically connected to one of said electrical conductors; and
an ignition aid comprising a coil of electrically conductive wire that is electrically attached to said frame member and is disposed around said arc tube.

2. The high intensity discharge lamp of claim 1 wherein said arc tube includes a central portion and two smaller sized legs each of which extends from said central portion, said central portion forming a discharge region inside said arc tube.

3. The high intensity discharge lamp of claim 2 wherein said coil of wire is disposed around one of said legs.

4. The high intensity discharge lamp of claim 1 wherein said coil of wire is welded to said frame member as a coil.

5. The high intensity discharge lamp of claim 1 wherein said coil of wire is welded to said frame member as an uncoiled wire that extends from said coil.

6. The high intensity discharge lamp of claim 1 wherein said discharge region comprises inert gas and a dose fill of mercury and metal halides.

7. The high intensity discharge lamp of claim 6 wherein a mixture of at least one of argon and xenon gas, and Kr⁸⁵ gas, present in the discharge region has an activity concentration of not greater than 0.16 MBq/liter.

8. The high intensity discharge lamp of claim 2 wherein said electrical conductors include a first conductor to which voltage is applied and a second conductor, wherein said frame member is electrically connected to said second conductor and said coil of wire is disposed around one of said legs but electrically insulated from said first electrical conductor.

9. The high intensity discharge lamp of claim 1 wherein said coil of wire is comprised of a base metal selected from the group consisting of Nb, Mo, Ta, Pt, Re, W, Ni, Fe and combinations thereof, or a combination of any of said base metals with cladding comprised of one or more of said base metals.

10. The high intensity discharge lamp of claim 2 wherein said coil of wire is wrapped around one of said legs of said arc tube more than 360 degrees.

11. The high intensity discharge lamp of claim 1 wherein said coil of wire has non-circular loops.

12. The high intensity discharge lamp of claim 1 wherein said coil of wire extends in loops around an axis that for most of a length of said coil of wire extends transverse to a longitudinal direction in which said electrical conductors extend.

13. A high intensity discharge lamp comprising:
an electrically insulating arc tube comprised of light transmissive material, wherein said arc tube includes a central portion and two smaller sized legs each of which extends from said central portion, said central portion forming a discharge region inside said arc tube;
electrical conductors each spaced apart from each other inside said central portion of said arc tube;
a shroud comprised of light transmissive material enclosing said arc tube;
an electrically conductive frame member disposed in an interior of said shroud that is electrically connected to one of said electrical conductors; and
an ignition aid that is electrically attached to said frame member comprising a coil of electrically conductive wire disposed around one of said legs.

14. The high intensity discharge lamp of claim 13 wherein said electrical conductors are disposed in said legs and said electrical conductor that is disposed in said leg that said coil of wire is disposed around is not connected to said frame member.

15. The high intensity discharge lamp of claim 13 wherein said coil of wire is welded to said frame member as a coil.

16. The high intensity discharge lamp of claim 13 wherein said coil of wire is welded to said frame member as an uncoiled wire that extends from said coil.

17. The high intensity discharge lamp of claim 13 wherein said discharge region comprises inert gas and a dose fill of mercury and metal halides.

18. The high intensity discharge lamp of claim 17 wherein a mixture of at least one of argon and xenon gas, and Kr⁸⁵ gas, present in the discharge region has an activity concentration of not greater than 0.16 MBq/liter.

19. The high intensity discharge lamp of claim 13 wherein said coil of wire is also disposed around said central portion of said arc tube except for a region between tips of said electrical conductors.

20. The high intensity discharge lamp of claim 13 wherein each of two said coils of wire are electrically attached to each of two said frame members in electrical contact with each of two said electrical conductors and are disposed around each of said legs having said electrical conductors at opposite potential to said coils of wire.

21. The high intensity discharge lamp of claim 13 wherein said coil of wire is wrapped around one of said legs of said arc tube more than 360 degrees.

22. The high intensity discharge lamp of claim 13 wherein said coil of wire has non-circular loops.

23. The high intensity discharge lamp of claim 13 wherein said coil of wire extends in loops around an axis that for most of a length of said coil of wire extends transverse to a longitudinal direction in which said electrical conductors extend.

24. The high intensity discharge lamp of claim 13 wherein said coil of wire is in a form of a coil at a location between said frame member and said arc tube.
